(19) United States
(12) Patent Application Publication
(10) Pub. No.: US 2014/0021852 A1
(43) Pub. Date: Jan. 23, 2014

(54) Water Resistant Direct Spark Igniter

(71) Applicant: RHEEM MANUFACTURING COMPANY, Atlanta, GA (US)

(72) Inventors: Raheel A. Chaudhry, Montgomery, AL (US); Troy Trant, Atlanta, GA (US); Timothy D. Scott, Tallassee, AL (US); Rodney K. Pugh, Wetumpka, AL (US)

(73) Assignee: Rheem Manufacturing Company, Atlanta, GA (US)

(21) Appl. No.: 13/749,768

(22) Filed: Jan. 25, 2013

Related U.S. Application Data
(60) Provisional application No. 61/672,820, filed on Jul. 18, 2012.

(51) Int. Cl. H01T 13/20

(52) U.S. Cl. CPC H01T 13/20
USPC 313/141

(57) ABSTRACT

A direct spark igniter for a fuel-fired heating appliance is provided with enhanced ignition performance in environments having substantial levels of both moisture and pollution. Such enhanced ignition performance is representatively achieved by the combination of (1) forming external annular ribs on the ceramic body portion of the igniter; (2) extending a top end of the igniter electrode rod into the body portion; (3) bending the igniter electrode and ground rods and angling them toward one another; and (4) knurling external side surfaces on lower end portions of the igniter electrode and ground rods.

### CROSS-REFERENCE TO RELATED APPLICATION

The present application claims the benefit of the filing date of provisional U.S. patent application no, 61/672,820 filed Jul. 18, 2012. The entire disclosure of the provisional application is hereby incorporated herein by this reference.

### BACKGROUND OF THE INVENTION

The present invention relates generally to direct spark igniters utilized in various types of fuel-fired heating appliances. More particularly, the present invention provides a direct spark igniter, representatively one useable in the combustion chamber of a downfired water heater, which is specially designed to satisfactorily operate in polluted, moisture-laden environments.

It has been observed in the fuel-fired appliance industry that various types of fuel-fired appliances utilizing direct spark igniters may experience improper behavior associated with no ignition event and/or delayed ignition. It has also been observed that conventionally designed direct spark igniters used, for example, in fuel-fired water heaters have little resistance to performance degradation arising when the igniters are operated in polluted and moisture-laden environments, thereby leading to improper spark operation. Because of this it can be readily seen that an improved direct spark igniter design, which provides improved operation in the presence of moisture and a substantial level of contamination/pollution, is needed. It is to this goal that the present invention is primarily directed.

### BRIEF DESCRIPTION OF THE DRAWINGS

FIG. 1 is a front elevational view of the igniter;

FIG. 2 is a side elevational view of the igniter taken along line 2-2 of FIG. 1; and

FIG. 3 is an enlargement of the dash-circled area in FIG. 2.

### DETAILED DESCRIPTION

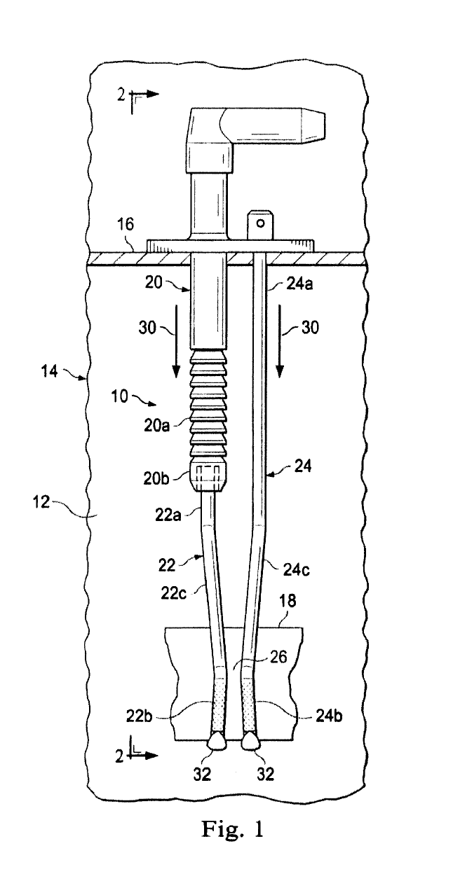

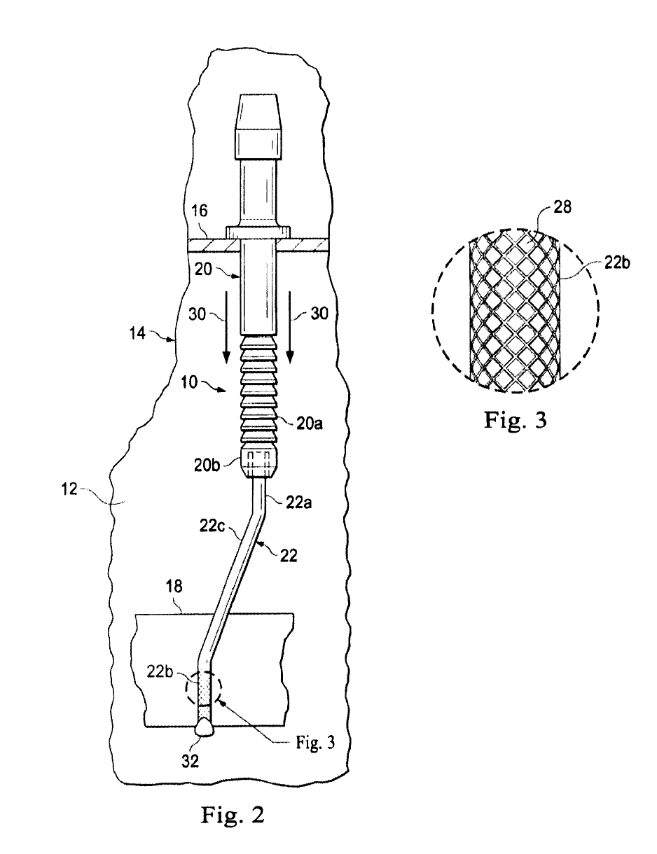

Turning first to FIGS. 1 and 2, in an illustrative embodiment thereof the present invention provides a specially designed direct spark igniter 10 which is representatively vertically oriented and extends downwardly into a combustion chamber portion 12 of a fuel-fired heating appliance 14 through an outer metal wall 16 of the combustion chamber 12. The igniter 10 is utilized to selectively ignite a fuel burner 18 in the combustion chamber 12 when heating operation of the appliance 14, representatively a downfired water heater in which the combustion chamber may have substantial levels of both moisture and pollution therein, is desired.

The vertically oriented igniter 10 comprises a vertically elongated cylindrical ceramic body 20 having an externally ribbed lower longitudinal portion 20a, and a hollow lower end 20b. Extending downwardly from the lower end 20b of the ceramic body 20 is an elongated high voltage electrode rod 22 having a vertically extending upper end portion 22a extending into the interior of the hollow lower ceramic body end 20b, a vertically extending lower end portion 22b, and a sloping longitudinally intermediate portion 22c which horizontally offsets the upper and lower rod portions 22a,22b from one another. Igniter 10 also includes a vertically elongated ground rod 24 having an upper longitudinal portion 24a opposite the ceramic body 20, a lower end portion 24b opposite the lower electrode rod end portion 22b, and a sloping longitudinally intermediate portion 24c which horizontally offsets the portions 24a,24b of the ground rod 24.

As can be seen from the front in FIG. 1, the rod portions 22c,24c slope downwardly and toward one another to form a minimum spark gap 26 between the rods 22,24. From the lower ends of the rod portions 22c,24c, the lower rod end portions 22b,24b slope downwardly and away from one another such that the lower ends of the rod portions 22b,24b are horizontally spaced away from one another by a distance greater than the width of the spark gap 26. For purposes later described, the lower rod end portions 22b,24b are externally knurled as at 28 (see FIG. 3 which shows the knurling on the exterior of the lower rod portion 22b).

To ignite the burner 18, high electrical voltage is supplied to the electrode rod 22 to create sparks across the rod gap 26 while fuel from an external source (not shown) is flowed to the burner 18, and combustion air 30 from an external source (also not shown) is flowed downwardly through the combustion chamber 12 outwardly along the igniter 10 to the burner 18.

Due to a unique combination of four features representatively incorporated therein, the igniter 10 is advantageously provided with enhanced ignition performance in environments having substantial levels of both moisture and pollution. Such features include:

1. the receipt of the upper end portion 22a of the high voltage electrode rod 22 within the hollow lower ceramic body end 20b that increases the creepage distance of the rod 22 to thereby increase the level of pollution that the igniter 10 may properly function in, while at the same time inhibiting water from making contact with the electrode rod 22 while providing a conduction path back to ground;

2. the provision of external annular ribs on the ceramic body portion that function to permit the downwardly flowing air 30 to deflect water traveling down the ribbed portion 20a horizontally away from the ceramic body 20, thereby lessening the amount of water flowing along the rod 22 to the juncture of its portions 22b,22c, and also increasing the electrode rod creepage distance along the exterior of the ceramic body 20;

3. the angled configuration of the igniter rods 22,24 that places the optimum spark gap 26 substantially higher than the lower ends of the rods 22,24, whereby water flowing downwardly along the rods will tend to collect (as at 32 in FIGS. 1 and 2) at the lower rod ends, tending to leave the spark area 26 dry; and

4. the external knurling 28 on the lower rod ends 22b,24b that provides more external surface area, and thus more “spark” area, and also creates “peaks” that project laterally outwardly beyond any water collecting on the lower rod ends, thereby further enhancing the operation of the igniter 10 in high moisture conditions.

While it has proven to be most preferable to provide the igniter 10 with a combination of all four of these features, substantial improvements to ignition performance of the igniter 10 in polluted, moisture laden environments may be obtained by incorporating a lesser number of these improvements (for example, any three thereof) into the igniter 10.

To applicants' knowledge there are no current direct spark igniters available that claim to work in high moisture and contamination conditions. In developing the igniter 10 described above, high voltage engineering principles were uniquely applied to the fuel fired appliance art to define igniters uniquely tailored for condensing appliances such as condensing type water heaters. A summary of these design techniques, along with definitions of various technical terms used herein, are set forth in the accompanying Exhibit A which forms a part of this patent application.

The foregoing detailed description is to be clearly understood as being given by way of illustration and example only, the spirit and scope of the present invention being limited solely by the appended claims.

### Exhibit A

### Summary

1. Spark Gap

The spark gap was calculated per the following formula.

$$V = 24.22 \times \frac{293 pd}{T} + 6.08 \times \sqrt{\frac{293 pd}{T}} \qquad -- - ( 1 )$$

Where V is the spark voltage, P is the gas pressure, d is spark gap, and T is temperature in Kelvin. The following gaps were calculated for a range of spark gap distance of pressure of 1 atm.

| Temperature | spark Gap |
|---|---|
| 0 F. | 3.417 mm |
| 27 F. | 3.6215 mm |
| 100 F. | 4.16 mm |
| 120 F. | 4.32 mm |

For temperature greater than 100 F, the spark occurs at less than 10 KV for any distance less than 3 mm. Therefore a spark gap of less than 3.08 mm is not advisable (at 120 F it generates exactly 10 KV). So our range becomes 3.08 to 4.08 mm after the installation (or 3.58+/−0.5 mm).

2. Creepage Distance

Creepage distance is the distance between the electrode and the nearest ground metal that is separated to the electrode by an insulation. This distance is defined in saveral high voltage transmission standards and varies with different levels of pollution [per UL60730]. In general, the following equations define this distance.

d=0.003ν−0.0778 for pollution degree 1 (PD1)

d=0.0046ν+0.2337 for (PD2)

d=0.0125ν+0.1 for (PD3)

d=0.02ν for (PD4)

Where d is the creepage distance and v is the rms spark voltage. Since most direct spark systems use voltages less than 20 KV, we will use 15 KVrms for this calculation.

Minimum Creepage Distance [mm]

| v [V] | PD1 | PD2 | PD3 | PD4 |
|---|---|---|---|---|
| 15000 | 44.9222 | 69.2337 | 187.6 | 300 |

Efforts were made for this design to meet pollution degree2 criterea, A custom ceramic design takes this distance to around 75 mm which is better than pollution degree II.

3. Clearance Distance

Clearance is the distance that is between the high voltage electrode and any other metal or other object around it (except the ground rod). To calculate the minimum clearance distance, the following equation from table 20.2 of UL60730 was used.

c=1.2034×ν−1.7

Where ν is the rated impulse voltage in kV and c is the clearance distance in mm. Since our max voltage is 20 kV, the value for c is calculated to be

c=22.37 mm

4. Ceramic Design

A custom ceramic design was implemented to increase the creepage distance in order to have a design that meets the pollution degree Ii criteria. The surface area of the ceramic was increased by adding ‘ribs’. Also, the end of the ceramic was left hollow. This serves dual purpose; it increases the creepage distance and also resists water from making contact with the electrode wire directly while providing a conduction path back to ground.

5. Design of the Electrode Wires

The electrode wires are also designed to resist water effects while sparking. The shape of the wires is such that the optimum spark gap is 18 mm higher than the lowest point. This lets any water droplets present to flow down due to the gravity and the air flow. To further increase the chances of spark in presence of water, the electrode wire surface at the lowest 30 mm is knurled; a feature that will have metal sticking out in the presence of water to continue the sparking. Furthermore, the lower area of electrodes is bent away from each other to provide optimum spark gap that is 18 mm higher than the lowest point.

### Explanation

### Spark Basics

Nothing explains the phenomenon of arcing between two points in a gas better than the Paschen's law. Paschen's law states that the breakdown characteristics of a gap are a non-linear function of the product of gas pressure and the gap length. Which can be written as

V=f(pd)² Equation 1

² High Voltage Engineering, Sec. Edition, MS Naidu and V Kamaraju, 1996 McGraw Hill, p. 27

Where V is the breakddown voltage or the voltage that is required to overcome the spark gap

p is pressure of the gas and

d is the gap distance.

It was observed by looking at the various Paschen's curves by Naidu that they vary within 1 kV of each other in different gases. Therefore, air could be used as the gas for our calculations. Paschen's law for air is

$$\begin{matrix}V = 24.22 \times \frac{293 pd}{T} + 6.08 \times \sqrt{\frac{293 pd}{T}} & 3\end{matrix} \qquad Equation 2$$

Where T is the temperature in Kelvin, p is the pressure in atm and d is the distance in cm. The calculated breakdown voltage is in kV.

Looking at the equation 2 on previous page, it is evident that the higher the temperature, the lower the breakdown voltage is going to be. Calculating for 0.39 cm gap distance and 1 atm pressure with 300K temperature, the breakdown voltage is 12.978 kV.

It is interesting to note that for air, and gaps on the order of mm, the breakdown is roughly a linear function of the gap length at room temperature. This relationship can be expressed as.

V=30×pd+1.35⁴ Equation 3

⁴ http://home.earthlink.net/-jimlux/hv/paschen.htm

Where breakdown voltage V is in kV, p is in atm and d is in cm. Using this expression the breakdown voltage for a 0.39 cm gap is calculated to be 13.05 kV which is fairly close approximation of the what we got while using equation 2 above (12.978 kV).

Other areas that affect the quality of spark are the clearance and creepage distances, the material of insulation and electrodes, and the diameter of the electrode (wire) itself.

### Spark Gap Calculation

Using equation 2 from previous page and considering that the lower the temperature, the higher is the breakdown voltage, the spark gap was calculated by using 270K of temperature, 1 atm of pressure, and the breakdown voltage that is ⅔ of the maximum voltage that could be provided by the board. Since the board can generate around 20 kV of maximum voltage, the breakdown voltage of 13.33 kV was used in the calculation.

$$13.33 = 24.22 \times \frac{293 \times 1 \times d}{270} + 6.08 \times \sqrt{\frac{293 \times 1 \times d}{270}}$$

And solving for d, the spark gap, we get a value of 0.36215 cm or

d=3.62 mm

### Creepage and Clearance Distance Calculations

The following definitions were used for the calculations.
I. Creeping discharge: A spark that travels to the ground along the dielectric plates, glass, polymer, or ceramics instead of happening at the spark gap.
II. Creepage distance is the distance between the electrode and the nearest ground metal that is separated to the electrode by an insulation. It is also the distance at which the creepage discharge occurs.
III. Clearance is the distance that is between the high voltage electrode and any other metal or other object around it (except the ground rod).
IV. Pollution degree 1: no pollution or only dry, non conductive pollution occurs. The pollution has no influence.
V. Pollution degree 2 Only non-conductive pollution occurs except that occasionally a temporary conductivity caused by condensation is to be expected.
VI. Pollution degree 3: Conductive pollution occurs or dry non-conductive pollution occurs which becomes conductive due to condensation which is to be expected.
VII. Pollution degree 4: The pollution generates persistent conductivty caused by the conductive dust or by rain or snow.
VIII. Proof Tracking Index (PTI): is used to measure the electrical breakdown (tracking) of an insulating material. It is the voltage at which, after the application of 0.1% ammonium chloride, samples pass the insulation test i.e. no current leaks through the insulation.
IX. Material group: Since we are using a ceramic that does not form any tracking for the proof tracking index (per Gene Price, ATS labs), we can assume material group 1 for our calculations.

### Creepage Distance

The minimum creepage distance calculations are based on the following equations

d=0.003ν−0.0778 for material group 1 (MG1) and pollution degree 1 (PD1)

d=0.0046νν+0.2337 for (MG1) and (PD2)

d=0.0125ν+0.1 for (MG1) and (PD3)

d=0.02ν for (MG1) and (PD4)

Where ν is the RMS voltage and d is the min creepage distance in mm. Considering that the max voltage our board can generate is 20 kV, which is 14.18 kV RMS, we are going to use 15 kV for the equations above and generate a table for min creepage distance at different pollution degrees.

Minimum Creepage Distance [mm]

| v [V] | PD1 | PD2 | PD3 | PD4 |
|---|---|---|---|---|
| 15000 | 44.9222 | 69.2337 | 187.6 | 300 |

Looking at the definitions, a condensing type fuel fired device is anticipated as either PD2 or PD3 and designing for the worst possible scenario, we need a creepage distance of at least 188 mm or 7.4 inches.

### Clearance Distance

To calculate the minimum clearance distance, the following equation was used.

c=1.2034×ν−1.7

Where v is the rated impulse voltage in kV and c is the clearance distance in mm.

Since our max voltage is 20 kV, the value for c is calculated to be

c=22.37 mm

### Observations

The colder the gas temperature the harder it is for a spark to overcome the spark gap⁵.
Creepage discharge starts happening at lower voltage than the breakdown voltage⁶. This happens specially when the insulation used is thin or has some conductive properties.
The breakdown voltage varies with the material of the electrode. Although, this variation remains within 1 kV⁷.
The safe temperature of 95% Alumina is 1600° C. (2912° F.) and it has a dielectric strength of 16 kV/mm⁸. Given a minimum insulation thickness of 1.5 mm the dielectric strength of 24 kV will be above the maximum anticipated load.
The most common cause of insulation failure is the presence of discharges either within the voids in the insulation or over the surface of the insulation⁹.
The products of discharges may deposit on solid insulation supports and may lead to surface breakdown over these solid supports¹⁰.
. . . the surface insulation failure (contamination) is the most frequent cause of [spark] trouble in practice¹¹. ⁵ Spark Discharge, EM Bazelyan and Yu P Raizer. CRS press 1998, p67⁶ Spark Discharge, EM Bazelyan and P Raizer CRS press 1998, p9⁷ High Voltage Engineering, Sec. Edition, MS Naidu and V Kamaraju, 1996 McGraw Hill p. 28⁸ High Voltage Engineering, Sec, Edition, MS Naidu and V Kamaraju, 1996 McGraw Hill, p. 81⁹ High Voltage Engineering, Sec. Edition, MS Naidu and V Kamaraju, 1996 McGraw Hill, p. 2¹⁰ High Voltage Engineering, Sec Edition. MS Naidu and V Kamaraju, 1996 McGraw Hill, p. 3¹¹ High Voltage Engineering, Sec. Edition, MS Naidu and V Kamaraju, 1996 McGraw Hill, p. 3

### Conclusion and Recommendations

The following parameters were calculated based on the equations noted in this report.
1. Spark gap=3.62 mm (at 27 F)
2. Minimum clearance=22 mm (+/−2).
3. Minimum Creepage=69 mm (for pollution degree 2).
4. Minimum distance from any fiber=10 cmm.
5. Ceramic design
A custom ceramic design was implemented to increase the creepage distance in order to have a design that meets the pollution degree Ii criteria. The surface area of the ceramic was increased by adding ‘ribs’. Also, the end of the ceramic was left hollow. This serves dual purpose; it increases the creepage distance and also resists water from making contact with the electrode wire directly while providing a conduction path back to ground.
6. Design of the electrode wires
The electrode wires are also designed to resist water effects while sparking. The shape of the wires is such that the optimum spark gap is 18 mm higher than the lowest point. This lets any water droplets, common with condensation based appliances, to flow down due to the gravity and the air flow. To further increase the chances of spark in presence of water, the electrode wire surface at the lowest 30 mm is knurled; a feature that will have metal sticking out in the presence of water to continue the sparking. Furthermore, the lower area of electrodes is bent away from each other to provide optimum spark gap that is 18 mm higher than the lowest point.

What is claimed is:

1. A vertically orientable moisture and pollution resistant direct spark igniter comprising:
a cylindrical ceramic body having external annular ribs thereon and a lower end into which an opening upwardly extends;
a vertically elongated high voltage electrode rod having an upper end received in said body opening; and
a vertically elongated ground rod supported in a spaced apart, generally side-by-side relationship with said body and said electrode rod,
lower end portions of said electrode rod and said ground rod being horizontally offset from upper end portions of said electrode rod and said ground rod by longitudinally intermediate portions of said electrode rod and said ground rod that slope downwardly and horizontally toward one another, said lower end portions of said electrode rod and said ground rod further having knurled external side surfaces and sloping downwardly and horizontally away from one another, juncture areas between said longitudinally intermediate and lower end portions of said electrode rod and said ground rod forming therebetween a spark gap area spaced upwardly apart from the lower ends of said electrode rod and said ground rod.

2. A vertically orientable moisture and pollution resistant direct spark igniter comprising:
a cylindrical ceramic body having external annular ribs thereon and a lower end;
a vertically elongated high voltage electrode rod longitudinally extending downwardly from said lower end of said ceramic body; and
a vertically elongated ground rod supported in a spaced apart, generally side-by-side relationship with said body and said electrode rod,
lower end portions of said electrode rod and said ground rod being horizontally offset from upper end portions of said electrode rod and said ground rod by longitudinally intermediate portions of said electrode rod and said ground rod that slope downwardly and horizontally toward one another, said lower end portions of said electrode rod and said ground rod further having knurled external side surfaces and sloping downwardly and horizontally away from one another, juncture areas between said longitudinally intermediate and lower end portions of said electrode rod and said ground rod forming therebetween a spark gap area spaced upwardly apart from the lower ends of said electrode rod and said ground rod.

3. A vertically orientable moisture and pollution resistant direct spark igniter comprising:
a cylindrical ceramic body having a lower end into which an opening upwardly extends;
a vertically elongated high voltage electrode rod having an upper end received in said body opening; and
a vertically elongated ground rod supported in a spaced apart, generally side-by-side relationship with said body and said electrode rod,
lower end portions of said electrode rod and said ground rod being horizontally offset from upper end portions of said electrode rod and said ground rod by longitudinally intermediate portions of said electrode rod and said ground rod that slope downwardly and horizontally toward one another, said lower end portions of said electrode rod and said ground rod further having knurled external side surfaces and sloping downwardly and horizontally away from one another, juncture areas between said longitudinally intermediate and lower end portions of said electrode rod and said ground rod forming therebetween a spark gap area spaced upwardly apart from the lower ends of said electrode rod and said ground rod.

4. A vertically orientable moisture and pollution resistant direct spark igniter comprising:
a cylindrical ceramic body having external annular ribs thereon and a lower end into which an opening upwardly extends;
a vertically elongated high voltage electrode rod having an upper end received in said body opening, and a lower end;
a vertically elongated ground rod supported in a spaced apart, generally side-by-side relationship with said body and said electrode rod and having a lower end, a narrowed spark gap area being formed between spaced apart portions of said electrode rod and said ground rod at a location spaced upwardly apart from said lower ends of said electrode rod and said ground rod; and
knurled external side surfaces disposed on lower end portions of said electrode rod and said ground rod.

5. A vertically orientable moisture and pollution resistant direct spark igniter comprising:
a cylindrical ceramic body having external annular ribs thereon and a lower end into which an opening upwardly extends;
a vertically elongated high voltage electrode rod having an upper end received in said body opening; and
a vertically elongated ground rod supported in a spaced apart, generally side-by-side relationship with said body and said electrode rod,
lower end portions of said electrode rod and said ground rod being horizontally offset from upper end portions of said electrode rod and said ground rod by longitudinally intermediate portions of said electrode rod and said ground rod that slope downwardly and horizontally toward one another, said lower end portions of said electrode rod and said ground rod further sloping downwardly and horizontally away from one another, juncture areas between said longitudinally intermediate and lower end portions of said electrode rod and said ground rod forming therebetween a spark gap area spaced upwardly apart from the lower ends of said electrode rod and said ground rod.
